(19) United States
(12) Patent Application Publication
(10) Pub. No.: US 2026/0131694 A1
(43) Pub. Date: May 14, 2026

(54) ENERGY MANAGEMENT SYSTEM AND METHOD FOR OPTIMIZING ELECTRIC LOADS TO MAXIMIZE POWER BACKUP DURATION

(71) Applicant: GM Global Technology Operations LLC, Detroit, MI (US)

(72) Inventors: Manali Deokate, Farmington Hills, MI (US); Cameron Christopher Rose, Heiskell, TN (US)

(21) Appl. No.: 18/942,147

(22) Filed: Nov. 8, 2024

(51) Int. Cl. B60L 55/00; B60L 58/12; H02J 3/00; H02J 3/28; H02J 3/46

(52) U.S. Cl. CPC B60L 55/00; B60L 58/12; H02J 3/003; H02J 3/28; H02J 3/466; H02J 2103/30; H02J 2105/42

(57) ABSTRACT

A method for determining a power source using a digital break-out box between a first energy source and a second energy source for powering a plurality of circuits by setting at least a first limit and a second limit, determining the state of charge of the power source, determining an available discharge energy, and classifying each circuit into categories. When the second energy source is in an unpowered state, the circuits that are to be powered by the first energy source are determined by comparing the available discharge energy to the first limit and second limit. When the second energy source is in a powered state, the circuits that are to be powered by the first energy source and the circuits that are to be powered by the second energy source are determined by comparing the current state of charge to the first limit and second limit.

The present disclosure generally relates to wallbox units, and more particularly to systems and methods for customizing and managing which circuits receive power from an external power source using a digital break-out box.

Break-out boxes are found within buildings, including homes and offices, and connect one or more power sources to one or more circuits connected to the building. Typically, the power source includes an energy grid and related infrastructure. However, with the advent of electric vehicles, it is possible to connect an electric vehicle with a battery to the building using the break-out box. Using the electric vehicle as a separate power source may be connected to a break-out box to provides power to the building during an energy grid power outage.

Thus, while wallbox units achieve their intended purpose, there is a need for a new and improved system and method for customizing a configuration of electric loads based on user optimization and other extrinsic factors.

### SUMMARY

According to several aspects, a method for customizing which of a plurality of circuits are connected to one of a first energy source and a second energy source using a digital break-out box is provided. The method may include determining a state of the second energy source, wherein the state includes one of: a powered state and an unpowered state. The second energy source is determined to be in the powered state when the digital break-out box is receiving power from the second energy source. The second energy source is determined to be in the unpowered state when the digital break-out box is not receiving power from the second energy source. When the state is in the unpowered state, the method may further include determining the energy source to be the first energy source. When the state is in the unpowered state, the method may further include determining a current state of charge of the first energy source. When the state is in the unpowered state, the method may further include setting at least a first discharge limit and a second discharge limit of the first energy source. When the state is in the unpowered state, the method may further include classifying the circuits of the plurality of circuits into at least a first category and a second category. When the state is in the unpowered state, the method may further include determining a maximum energy demand based on the power used by the plurality of circuits over a time period. When the state is in the unpowered state, the method may further include determining a minimum energy demand based on the power used by the plurality of circuits in the first category over the time period. When the state is in the unpowered state, the method may further include determining an available discharge energy based on the summation of each limit subtracted from the current state of charge multiplied by an energy battery capacity. When the state is in the unpowered state, the method may further include comparing the available discharge energy to the first discharge limit and the second discharge limit to determine which of the plurality of circuits will be powered by the first energy source when the available discharge energy is less than the minimum energy demand and the available discharge energy is greater than the maximum energy demand.

In an additional aspect of the present disclosure, setting the first discharge limit and the second discharge limit may further include setting the first discharge limit to a first calibrated value based on discharge energy and setting the second discharge limit to a second calibrated value based on discharge energy, wherein the first calibrated value is greater than the second calibrated value.

In another aspect of the present disclosure, classifying the circuits of the plurality of circuits into at least a first category and a second category may further include classifying the circuits of the plurality of circuits into the first category based on a user's arbitrary preferences and classifying the circuits of the plurality of circuits into the second category based on the user's arbitrary preferences.

In an additional aspect of the present disclosure, determining the maximum energy demand may further include taking the total value of the power used by the plurality of circuits in the first category and multiplying the total value by a calibrated value of time.

In another aspect of the present disclosure, determining the maximum energy demand may further include taking the greater value between the power used by the plurality of circuits in the first category multiplied by a storm time and the energy used by the plurality of circuits in the first category multiplied by a power outage time.

In an additional aspect of the present disclosure, determining the minimum energy demand may further include taking the total amount of the power used by the plurality of circuits in the second category and multiplying the total value by a calibrated value of time.

In another aspect of the present disclosure, determining the minimum energy demand may further include taking the greater value between the power used by the plurality of circuits in the second category multiplied by a storm time and the energy used by the plurality of circuits in the second category multiplied by a power outage time.

In an additional aspect of the present disclosure, determining which of the plurality of circuits will be powered by the first energy source may further include powering the plurality of circuits in the first category and the second category when the available discharge energy is greater than the first discharge limit.

In another aspect of the present disclosure, determining which of the plurality of circuits will be powered by the first energy source may further include powering the plurality of circuits in the second category when the available discharge energy is less than the first discharge limit and the available discharge energy is greater than the second discharge limit.

In an additional aspect of the present disclosure, determining which of the plurality of circuits will be powered by the external power source may further include powering the plurality of circuits in the first category and the second category when the available discharge energy is greater than the maximum energy demand.

In another aspect of the present disclosure, determining which of the plurality of circuits will be powered by the first energy source may further include powering the plurality of circuits in the second category when the available discharge energy is less than the minimum energy demand and the available discharge energy is greater than the second discharge limit.

In an additional aspect of the present disclosure, the first energy source may be a vehicle.

In another aspect of the present disclosure a method for customizing which of the plurality of circuits are connected to one of the first energy source and the second energy source using the digital break-out box is provided. The method may include determining the state of the second energy source, wherein the state includes one of: the powered state and the unpowered state. When the state is in the powered state, the method may further include determining the current state of charge of the first energy source. When the state is in the powered state, the method may further include setting at least a first drop-off limit with a corresponding first drop-off limit power and a second drop-off limit with a corresponding second drop-off limit power of the first energy source. When the state is in the powered state, the method may further include classifying the circuits of the plurality of circuits into at least a first drop-off area and a second drop-off area. When the state is in the powered state, the method may further include comparing the current state of charge to the first drop-off limit and the second drop-off limit to determine which energy source will power the plurality of circuits.

In an additional aspect of the present disclosure, setting the first drop-off limit and the second drop-off limit may further include setting the first drop-off limit to a third calibrated value based on the current state of charge, setting the first drop-off limit power to a fourth calibrated value in terms of power, setting the second drop-off limit to a fifth calibrated value based on the current state of charge, and setting the second drop-off limit power to a sixth calibrated value in terms of power wherein the third calibrated value is greater than the fifth calibrated value and the fourth calibrated value is less than the sixth calibrated value.

In another aspect of the present disclosure, classifying the circuits of the plurality of circuits into at least a first drop-off area and a second drop-off area may further include determining the amount of power each individual circuit uses, classifying the individual circuit into the first drop-off area when the amount of power the individual circuit uses is less than the first drop-off limit power, and classifying the individual circuit into the second drop-off area when the amount of power the individual circuit uses is greater than or equal to the first drop-off limit power and is less than the second drop-off limit power.

In an additional aspect of the present disclosure, determining which energy source will power the plurality of circuits may further include powering the plurality of circuits in the first drop-off area and the second drop-off area using the first energy source when the current state of charge is greater than the first drop-off limit.

In another aspect of the present disclosure, determining which energy source will power the plurality of circuits may further include powering the plurality of circuits in the second drop-off area using the first energy source when the current state of charge is less than the first drop-off limit and the current state of charge is greater than the second drop-off limit and powering the plurality of circuits in the first drop-off area using the second energy source when the current state of charge is less than the first drop-off limit and the current state of charge is greater than the second drop-off limit.

In an additional aspect of the present disclosure, determining which energy source will power the plurality of circuits may further include powering the plurality of circuits in the first drop-off area and the second drop-off area using the second energy source when the current state of charge is less than or equal to the second drop-off limit.

In another aspect of the present disclosure, the first energy source may be a vehicle.

In an additional aspect of the present disclosure, a method for customizing which of the plurality of circuits are connected to one of the first energy source and the second energy source using the digital break-out box is provided. The method may include determining the state of the second energy source, wherein the state includes one of: the powered state and the unpowered state. When the state is in the unpowered state, the method may further include determining the energy source to be the first energy source. When the state is in the unpowered state, the method may further include determining the current state of charge of the first energy source. When the state is in the unpowered state, the method may further include setting at least a first discharge limit and a second discharge limit of the first energy source. When the state is in the unpowered state, the method may further include classifying the circuits of the plurality of circuits into at least a first category and a second category. When the state is in the unpowered state, the method may further include determining a maximum energy demand based on the energy used by the plurality of circuits in the first category over a time period. When the state is in the unpowered state, the method may further include determining a minimum energy demand based on the energy used by the plurality of circuits in the second category over the time period. When the state is in the unpowered state, the method may further include determining an available discharge energy based on the summation of each limit subtracted from the current state of charge multiplied by an energy battery capacity. When the state is in the unpowered state, the method may further include comparing the available discharge energy to the first discharge limit and the second discharge limit to determine which of the plurality of circuits will be powered by the first energy source when the available discharge energy is less than the minimum energy demand and the available discharge energy is greater than the maximum energy demand. When the state is in the powered state, the method may further include determining the current state of charge of the first energy source. When the state is in the powered state, the method may further include setting at least a first drop-off limit with a corresponding first drop-off limit power and a second drop-off limit with a corresponding second drop-off limit power of the first energy source. When the state is in the powered state, the method may further include classifying the circuits of the plurality of circuits into at least a first drop-off area and a second drop-off area. When the state is in the powered state, the method may further include comparing the current state of charge to the first drop-off limit and the second drop-off limit to determine which energy source will power the plurality of circuits.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 a schematic diagram of a system for customizing a configuration of a digital break-out box according to an exemplary embodiment;

FIG. 2 is a schematic diagram of an application using an input device for customizing the configuration of the digital break-out box according to an exemplary embodiment;

FIG. 3 is a diagram of available discharge energy of a first energy source used by the digital break-out box;

FIG. 4 is a diagram of a total battery capacity of the first energy source used by the digital break-out box;

FIG. 5 is a flow chart of a method for determining which of a plurality of circuits are powered by the first energy source using the digital break-out box when a second energy source is in an unpowered state according to an exemplary embodiment; and

FIG. 6 is a flow chart of a method for determining which of the plurality of circuits are powered by the first energy source and which of the plurality of circuits are powered by the second energy source using the digital break-out box when the second energy source is in the powered state according to an exemplary embodiment.

### DETAILED DESCRIPTION

The following description is merely exemplary in nature and is not intended to limit the present disclosure, application, or uses.

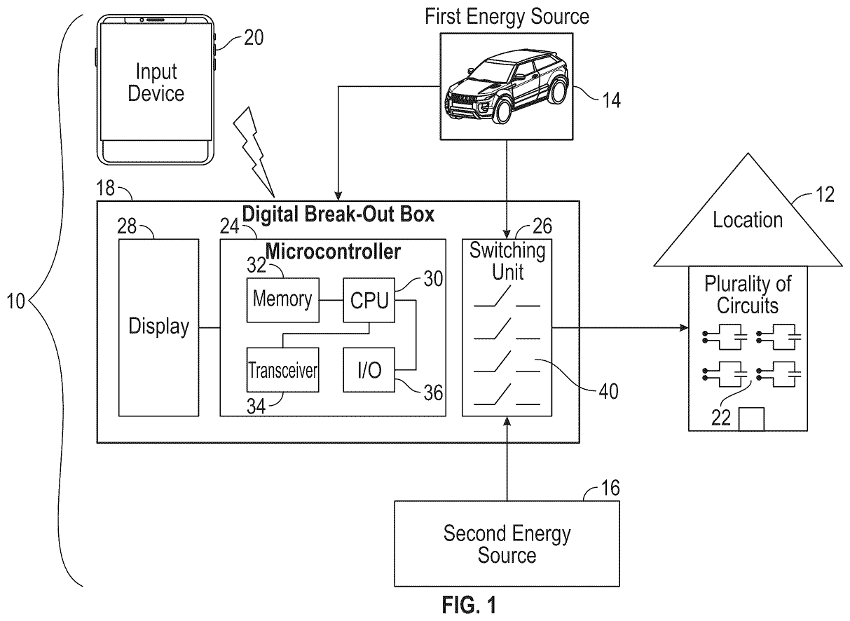

Referring to FIG. 1, a schematic diagram of a system for customizing which of a plurality of circuits are connected to which of a plurality of energy sources using a digital break-out box is generally indicated by reference number 10. The system 10 generally includes a powered location 12, a first energy source 14, a second energy source 16, a digital break-out box 18, and an input device 20.

The powered location 12 is any structure, building, or other location that can be configured to receive power. While the powered location 12 is illustrated as a home for purposes of this disclosure, it should be appreciated that the powered location 12 may take various forms. For example, the powered location 12 may be an office building or a warehouse. The powered location 12 may also include any location that includes equipment that is configured to receive power, such as a construction site. The powered location 12 generally includes a plurality of circuits 22. The plurality of circuits 22 are one or more separate wires that are connected to one or more objects configured to receive power, such as appliances, equipment, batteries, etc. Therefore, each of the plurality of circuits 22 is defined as a closed loop connected to the objects configured to receive power. Each of the plurality of circuits 22 may further include switches, fuses, and other electrical devices.

The first energy source 14 is connected to the plurality of circuits 22 via the digital break-out box 18. The first energy source 14 is any energy source capable of providing energy to power all of the circuits 22 at the powered location 12. In the example provided, the first energy source 14 is an energy grid. The energy grid includes power plants and infrastructure (not shown) capable of providing power to the plurality of circuits 22. The first energy source 14 is the default provider of power to the powered location 12.

The second energy source 16 is an energy source separate and apart from the first energy source 14. In one example, the second energy source 16 is a battery equipped vehicle. In another example, the second energy source 16 is a generator. The second energy source 16 is connectable to the plurality of circuits 22 via the digital break-out box 18, as will be described in greater detail below.

The digital break-out box 18 is used to selectively connect one of the first energy source 14 and the second energy source 16 to one or more of the plurality of circuits 22. In one example, the digital break-out box 18 is permanently mounted or connected to the powered location 12 (for example, fixed to the home). Alternatively, the digital break-out box 18 may be a separate portable unit. The digital break-out box 18 includes a controller 24, a switching unit 26, and a display 28.

The controller 24 is a non-generalized, electronic control device having a preprogrammed digital computer or processor 30, memory 32, a transceiver 34, and input and output ports 36. The processor 30 may be a custom made or commercially available processor, a central processing unit (CPU), a graphics processing unit (GPU), an auxiliary processor among several processors associated with the controller 24, a semiconductor-based microprocessor (in the form of a microchip or chip set), a macroprocessor, a combination thereof, or generally a device for executing instructions. The memory 32 is used to store data such as control logic, software applications, instructions, computer code, data, lookup tables, etc. The memory 32 includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code. The processor 30 is configured to execute the code or instructions.

The transceiver 34 is configured to wirelessly communicate with the hotspot using Wi-Fi protocols under IEEE 802.11x standards. The transceiver 34 is also configured to wirelessly communicate using cellular data communication under GSMA standards, such as SGP.02, SGP.22, SGP.32, and the like. Suitably, the digital break-out box 18 may further include an embedded universal integrated circuit card (eUICC) configured to store at least one cellular connectivity configuration profile, for example, an embedded subscriber identity module (eSIM) profile. The transceiver 34 is further configured to communicate via a personal area network (e.g., BLUETOOTH), near-field communication (NFC), and/or any additional type of radiofrequency communication.

The input and output ports 36 receive incoming data from the input device 20 and the first energy source 14 and communicate the incoming data to the processor 30. The input and output ports 36 also receive outgoing data from the processor 30 and communicate and outgoing data to the input device 20 and the first energy source 14. The input and output ports 36 are configured to wirelessly communicate with the input device 20 and the first energy source 14 via the transceiver 34 and are also configured to communicate with the input device 20 and the first energy source 14 through a Universal Serial Bus (USB) wired connection.

The controller 24 may further include one or more applications. The application is a software program configured to perform a specific function or set of functions. The applications may include one or more computer programs, software components, sets of instructions, procedures, functions, objects, classes, instances, related data, or a portion thereof adapted for implementation in a suitable computer readable program code. The applications may be stored within the memory 32 or in additional or separate memory. Examples of the applications include audio or video streaming services, games, browsers, social media, etc.

The switching unit 26 includes a plurality of switches 40 where each switch has an enabled state and a disabled state. The switches from the plurality of switches 40 are coupled between the first energy source 14, the second energy source 16, and the plurality of circuits 22. The switching unit 26 receives power from the first energy source 14 and the second energy source 16. When an individual switch from the plurality of switches 40 is in the enabled state, the individual switch allows the power received from the first energy source 14 and the second energy source 16 to flow through and power a corresponding individual circuit from the plurality of circuits 22. When an individual switch from the plurality of switches 40 is in the disabled state, the individual switch stops the flow of power from the first energy source 14 and the second energy source 16 to a corresponding individual circuit from the plurality of circuits 22, meaning that the corresponding individual circuit from the plurality of circuits 22 does not receive any power. The controller 24 determines which switches from the plurality of switches 40 are in the enabled state and the disabled state based on data communicated to the controller 24 by the input device 20 and the first energy source 14.

The display 28 is a screen that is appended to the digital break-out box 18 that has a human-machine interface that allows a user to customize the digital break-out box 18. The display 28 is an optional feature, meaning that the digital break-out box 18 does not need to have the display 28.

The input device 20 is a device that communicates outgoing data to the transceiver 34. The input device 20 comprises a screen for display purposes and a human-machine interface to allow the user to customize the digital break-out box 18 from the input device 20. While the input device 20 is illustrated as a mobile phone for the purposes of this disclosure, it should be appreciated that the input device 20 may take various forms. For example, the input device 20 may be a tablet, a smart watch, a laptop, or a desktop computer.

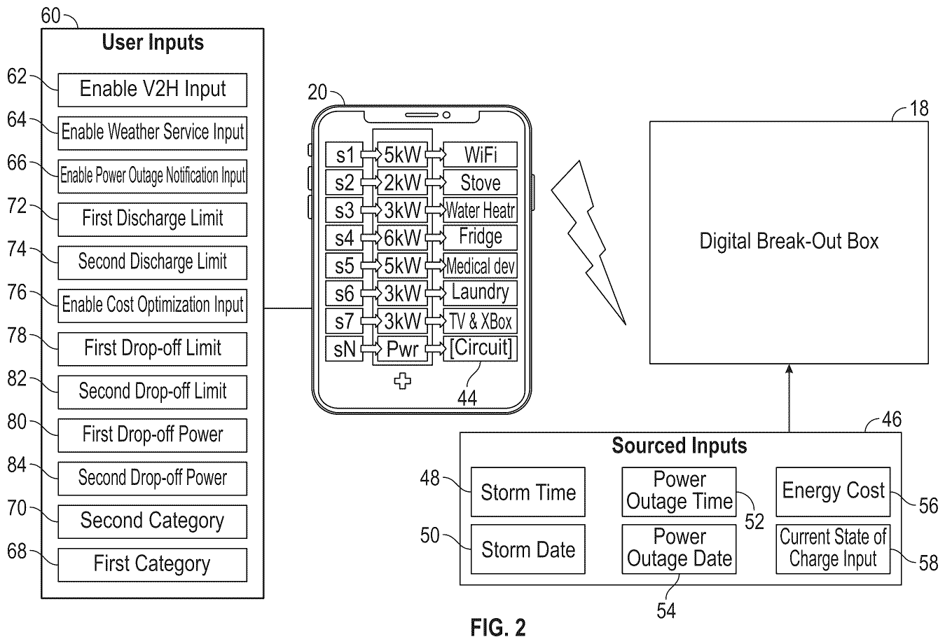

Referring to FIG. 2, an example of an application 44 for customizing the digital break-out box 18 is illustrated using the input device 20. It should be appreciated that the application 44 may also be employed using directly with the digital break-out box 18 using the display 28 and a human-machine interface connected to the digital break-out box 18. The application 44 is configured to allow the user to categorize each of the plurality of circuits 22, set discharge and drop-off limits, and enable and disable the utilization of sourced inputs. For example, each of the plurality of circuits 22 are listed by the application 44 as circuits S1 to SN. A maximum power usage is associated for each of the plurality of circuits 22. The maximum power usage is the total power required to fully power each object or device connected to each of the circuits S1 to SN. The application 44 allows the user to name or label each of the circuits S1 to SN. In addition, each of the circuits S1 to SN are categorized as will be described in greater detail below.

The application 44 is configured to receive a plurality of sourced inputs 46. The sourced inputs 46 are communicated directly to the digital break-out box 18 via a wireless signal and received by the transceiver 34. The sourced inputs 46 are not calibrated by the user. Alternatively, the sourced inputs 46 may be communicated to the input device 20. The sourced inputs 46 include a storm time 48, a storm date 50, a power outage time 52, a power outage date 54, an energy cost 56, and a current state of charge input 58.

The storm time 48 is data that describes the projected length of a storm over a period of time. The storm date 50 is data that indicates the day or dates of a projected storm. In an example, the storm time 48 and the storm date 50 are communicated directly to the digital break-out box 18 from a weather service and are then recorded in the memory 32. In another example, the storm time 48 and the storm date 50 are communicated to the digital break-out box 18 via the first energy source and are then recorded in the memory 32. In another example, the storm time 48 and the storm date 50 are communicated to the digital break-out box 18 via the application 44 on the device 20 and are then recorded in the memory 32.

The power outage time 52 is data that indicates a scheduled power outage length of the second energy source 16 over a period of time. The power outage date 54 is data that indicates the day or dates of a scheduled power outage of the second energy source 16. In an example, the power outage time 52 and the power outage date 54 are communicated directly to the digital break-out box 18 from an energy service provider and are then recorded in the memory 32. In another example, the power outage time 52 and the power outage date 54 are communicated to the digital break-out box 18 via the first energy source 14 and are then recorded in the memory 32. In another example, the power outage time 52 and the power outage date 54 are communicated to the digital break-out box 18 via the application 44 on the device 20 and are then recorded in the memory 32.

The energy cost 56 is data that describes the energy cost of each circuit from the plurality of circuits 22. The energy cost 56 is the maximum energy cost associated with any devices or other energy drains on the individual circuit. In an example, the energy cost 56 is communicated directly to the digital break-out box 18 from the energy service provider and then recorded in the memory 32. In another example, the energy cost 56 is communicated to the digital break-out box 18 via the first energy source 14 and then recorded in the memory 32. In another example, the energy cost 56 is communicated to the digital break-out box 18 via the application 44 on the device 20 and then recorded in the memory 32.

The current state of charge input 58 is data that describes the level of charge remaining in the first energy source 14. The current state of charge input 58 may include a voltage, an estimated level of charge, or a specific gravity of a fluid, though it should be appreciated that other data may be included. The current state of charge input 58 is communicated directly to the digital break-out box 18 from the first energy source 14 and then recorded in the memory 32.

In addition to the plurality of sourced inputs 46, the application 44 receives a plurality of user inputs 60. The input device 20 is configured to receive the plurality of user inputs 60. The plurality of user inputs 60 are used to customize optimization settings of the power supplied to the powered location 12. The plurality of user inputs 60 are calibrated by the user entering the plurality of user inputs 60 into the input device 20. The plurality of user inputs 60 include: an enable vehicle to home (V2H) input 62, an enable weather service input 64, an enable power outage notification input 66, a first category 68, a second category 70, first discharge limit 72, a second discharge limit 74, an enable cost optimization input 76, a first drop-off limit 78, a first drop-off limit power 80, a second drop-off limit 82, and a second drop-off limit power 84.

The enable V2H input 62 is used to enable switching power sources between the first energy source 14 and the second energy source 16. The enable V2H input 62 is a binary input with a true calibration where the system 10 is enabled and a false calibration where the system 10 is disabled.

The enable weather service input 64 is used to communicate weather data from a remote weather service to the digital break-out box 18. The enable weather service input 64 is a binary input with a true calibration where the weather data is communicated to the digital break-out box 18 and a false calibration where the weather data is not communicated to the digital break-out box 18. The weather data includes weather related information that is relevant to the powered location 12.

The enable power outage notification input 66 is used to communicate power data from an operator of an energy grid to the digital break-out box 18. The enable power outage notification input 66 is a binary input with a true calibration where the power data is communicated to the digital break-out box 18 and a false calibration where the power data is not communicated to the digital break-out box 18. The power data includes information related to planned power outages or other issues related to operation of an energy grid.

The first category 68 is calibrated by the user wherein the user can set each circuit from the plurality of circuits 22 as belonging to the first category 68 based on the user's 42 arbitrary preferences. The first category 68 is then recorded in the memory 32. In an example, the user sets circuits from the plurality of circuits 22 as belonging in the first category 68 when the user, based on their own arbitrary preferences, decides that the circuits are “non-essential” circuits. This means that the powering of the circuits placed into the first category 68 will not be prioritized over the powering of circuits not placed into the second category 70.

The second category 70 is calibrated by the user wherein the user can set each circuit from the plurality of circuits 22 as belonging to the second category 70 based on the user's 42 arbitrary preferences. The second category 70 is then recorded in the memory 32. In an example, the user sets circuits from the plurality of circuits 22 as belonging in the second category 70 when the user, based on their own arbitrary preferences, decides that the circuits are “essential” circuits. This means that the powering of the circuits placed into the second category 70 will be prioritized over the powering of circuits placed into the first category 68.

In another example, there is a third category alongside the first category 68 and the second category 70, where the user sets circuits from the plurality of circuits 22 as belonging in the first category 68, the second category 70, or the third category. The user, based on their own arbitrary preferences, decides that the circuits they set as belonging to the first category 68 are “non-essential” circuits, meaning that the powering of the first category 68 circuits will not be prioritized over the powering of “essential” circuits placed into the second category 70. Additionally, the user, based on their own arbitrary preferences, decides that the circuits they set as belonging to the third category are “critical” circuits, meaning that the powering of the third category circuits will be prioritized over the powering of both the “non-essential” circuits placed into the first category 68 and the “essential” circuits placed into the second category 70. In another example, the user sets circuits from the plurality of circuits 22 for a plurality of categories, listed as C1 to CN, where the powering of the circuits in each subsequent category is prioritized over the previous categories based on the arbitrary preferences of the user.

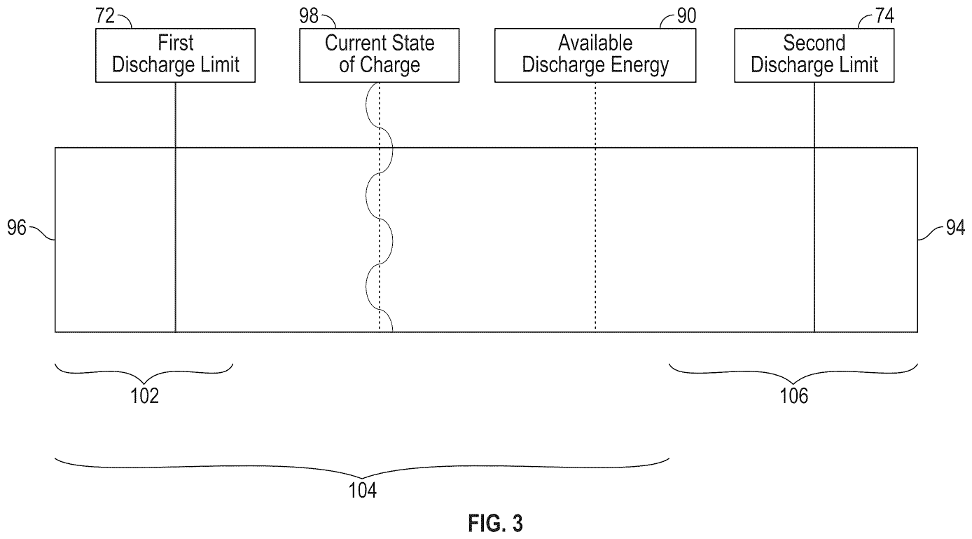

Referring to FIG. 3, a diagram of available discharge energy of the first energy source 14 is shown. The available discharge energy, indicated by reference number 90, represents an available amount of energy the first energy source 14 can deliver based on an energy battery capacity of the first energy source 14 relative to a minimum total discharge capacity 94 and a maximum total discharge capacity 96. The available discharge energy 90 is an amount of energy of the first energy source 14 at any given time is therefore between the minimum total discharge capacity 94 and the maximum total discharge capacity 96.

The available discharge energy 90 is determined and then compared to the first discharge limit 72 and the second discharge limit 74 to determine which of the plurality of circuits 22 will be powered by the first energy source 14. In an example, the available discharge energy 90 is determined by subtracting the first discharge limit 72 from a current state of charge 98 and multiplying the result by an energy battery capacity, which is then added to the result of the second discharge limit 74 subtracted from the current state of charge 98 and multiplied by the energy battery capacity. The energy battery capacity is the high voltage battery capacity of the first energy source 14. The available discharge energy 90 is then recorded in the memory 32.

Referring to FIG. 2, the current state of charge 98 is determined from the current state of charge input 58 from the first energy source 14. In one example, the current state of charge 98 is determined by measuring the voltage of the first energy source 14. In another example, the current state of charge 98 is determined by measuring the specific gravity of the first energy source 14 using the electrolyte of the first energy source 14. It should be appreciated that other methods of determining the current state of charge 98 may be employed.

The first discharge limit 72 is calibrated by the user as a first calibrated value in terms of energy and is a limit that the available discharge energy 90 is compared to determine whether the plurality of circuits in the both the first category 68 and the second category 70 will be powered by the first energy source 14 or the plurality of circuits in the second category 70 will be powered by the first energy source 14. The first discharge limit 72 is then communicated to the digital break-out box 18 and recorded in the memory 32. The digital break-out box 18 can modify the first discharge limit 72 using machine learning algorithms stored in the processor 30 to optimize the period of time the first energy source 14 powers the plurality of circuits 22.

For example, referring to FIG. 3, when the available discharge energy 90 is greater than the first discharge limit 72, the plurality of circuits in the first category 68 and the second category 70 are powered by the first energy source 14, which is generally indicated by reference number 102. When the available discharge energy 90 is less than the first discharge limit 72 and the available discharge energy 90 is greater than the second discharge limit 74, the plurality of circuits in the second category 70 are powered by the first energy source 14, which is generally indicated by reference number 104.

Returning to FIG. 2, the second discharge limit 74 is calibrated by the user as a second calibrated value in terms of energy and is a limit that the available discharge energy is compared to determine whether the plurality of circuits in the second category 70 will be powered by the first energy source 14 or none of the circuits in the plurality of circuits 22 will receive power from the first energy source 14. The second calibrated value of the second discharge limit 74 is less than the first calibrated value of the first discharge limit 72. The second discharge limit 74 is then communicated to the digital break-out box 18 and recorded in the memory 32. The digital break-out box 18 can modify the second discharge limit 74 using machine learning algorithms stored in the processor 30 to optimize the period of time the first energy source 14 powers the plurality of circuits 22. In this example, the second discharge limit 74 would be a minimum discharge limit, meaning that when the available discharge energy 90 is less than or equal to the second discharge limit 74, the first energy source 14 will no longer power any of the plurality of circuits 22. It should be appreciated that the second discharge limit 74 is not required to be a minimum discharge limit when there are more than the first category 68 and the second category 70, which is described in greater detail below.

For example, referring to FIG. 3, when the available discharge energy 90 is less than the first discharge limit 72 and the available discharge energy 90 is greater than a second discharge limit 74, the plurality of circuits in the second category 70 are powered by the first energy source 14, which is generally indicated by reference number 104. When the available discharge energy 90 is less than the second discharge limit 74, none of the plurality of circuits 22 are powered by the first energy source 14, which is generally indicated by reference number 106.

Returning to FIG. 2, when there are the plurality of categories, the user will set a plurality of discharge limits, listed as DL1 to DLN, where the discharge limit DLN-1 is calibrated at a value greater than the value of the discharge limit DLN and the number of discharge limits in the plurality of discharge limits is one greater than the number of categories in the plurality of categories. The discharge limit DLN would be a minimum discharge limit, meaning that when the available discharge energy 90 is less than or equal to the discharge limit DLN, the first energy source 14 will no longer power any of the plurality of circuits 22.

Referring to FIG. 3, when there are the plurality of categories and the plurality of discharge limits, when the available discharge energy 90 is less the discharge limit DLN-1 and the available discharge energy 90 is greater than the discharge limit DLN, the plurality of circuits in the CN category are powered by the first energy source 14. When the available discharge energy 90 is less than the discharge limit DLN, the first energy source 14 will no longer power any of the plurality of circuits 22.

In an example when there are the plurality of categories and the plurality of discharge limits, the available discharge energy 90 is determined from the summation of each of the plurality of discharge limits subtracted from the current state of charge 98 and multiplied by the energy battery capacity. The available discharge energy 90 is then recorded in the memory 32.

Returning to FIG. 2, the enable cost optimization input 76 is used to communicate optimization data to the digital break-out box 18. The enable cost optimization input 76 is a binary input with a true calibration where the optimization data is communicated to the digital break-out box 18 and a false calibration where the optimization data is not communicated to the digital break-out box 18. The optimization data includes the energy cost 56, which will be described in greater detail below.

The first drop-off limit 78 is calibrated by the user as a third calibrated value in terms of state of charge and is a limit that the current state of charge 98 is compared to determine whether the plurality of circuits in a first drop-off area and a second drop-off area will be powered by the first energy source 14 or the plurality of circuits in the second drop-off area will be powered by the first energy source 14. The first drop-off limit 78 is then communicated to the digital break-out box 18 and recorded in the memory 32. In an example when the enable cost optimization input 76 is calibrated to true, the digital break-out box 18 can modify the first drop-off limit 78 using machine learning algorithms stored in the processor 30 to optimize the cost savings of the system 10 based on the energy cost 56.

The first drop-off limit power 80 is calibrated by the user as a fourth calibrated value in terms of power and corresponds to the first drop-off limit 78 in determining whether circuits from the plurality of circuits 22 will be categorized in the first drop-off area or the second drop-off area based on the circuits' power consumption. The first drop-off limit power 80 is then communicated to the digital break-out box 18 and recorded in the memory 32. In an example when the enable cost optimization input 76 is calibrated to true, the digital break-out box 18 can modify the first drop-off limit power 80 using machine learning algorithms stored in the processor 30 to optimize the cost savings of the system 10 based on the energy cost 56.

The second drop-off limit 82 is calibrated by the user as a fifth calibrated value in terms of state of charge and is a limit that the current state of charge 98 is compared to determine whether the plurality of circuits in the second drop-off area will be powered by the first energy source 14 or none of the circuits in the plurality of circuits 22 will receive power from the first energy source 14. The fifth calibrated value of the second drop-off limit 82 is less than the third calibrated limit of the first drop-off limit 78. The second drop-off limit 82 is then communicated to the digital break-out box 18 and recorded in the memory 32. In an example when the enable cost optimization input 76 is calibrated to true, the digital break-out box 18 can modify the second drop-off limit 82 using machine learning algorithms stored in the processor 30 to optimize the cost savings of the system 10 based on the energy cost 56. In this example, the second drop-off limit 82 would be a minimum drop-off limit, meaning that when the current state of charge 98 is less than or equal to the second drop-off limit 82, the second energy source 16 will power the plurality of circuits 22. It should be appreciated that the second drop-off limit 82 is not required to be a minimum drop-off limit when there are more than the first drop-off area and the second drop-off area, which is described in greater detail below.

The second drop-off limit power 84 is calibrated by the user as a sixth calibrated value in terms of power and corresponds to the second drop-off limit 82 in determining when the plurality of circuits in the second drop-off area will no longer receive power from the first energy source 14 and will be powered by the second energy source 16. The sixth calibrated value of the second drop-off limit power 84 is greater than the fourth calibrated value of the first drop-off limit power 80. The second drop-off limit power 84 is then communicated to the digital break-out box 18 and recorded in the memory 32. In an example when the enable cost optimization input 76 is calibrated to true, the digital break-out box 18 can modify the second drop-off limit power 84 using machine learning algorithms stored in the processor 30 to optimize the cost savings of the system 10 based on the energy cost 56.

The circuits in the plurality of circuits 22 that consume power less than the first drop-off limit power 80 are categorized into the first drop-off area. The circuits in the plurality of circuits 22 that consume power greater than or equal to the first drop-off limit power 80 but consume power less than the second drop-off limit power 84 are categorized into the second drop-off area.

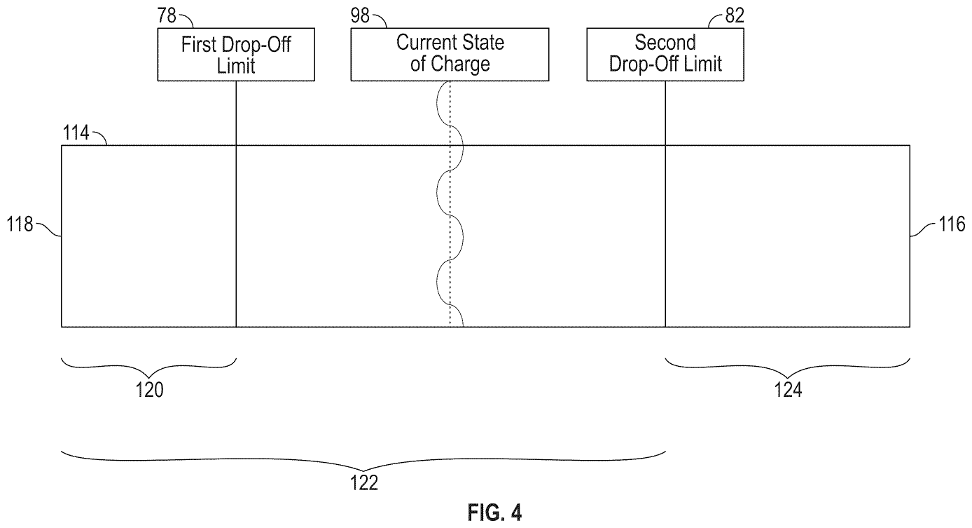

Referring to FIG. 4, a diagram of a total battery capacity 114 of the first energy source 14 used by the digital break-out box 18 is shown. The current state of charge 98 is relative to a minimum state of charge 116 and a maximum state of charge 118. The current state of charge 98, being the amount of charge the first energy source 14 is holding at any given time, is therefore between the minimum state of charge 116 and the maximum state of charge 118. The total battery capacity 114 is the maximum state of charge 118 that the first energy source 14 can hold.

When the current state of charge 98 is greater than the first drop-off limit 78, the plurality of circuits in the first drop-off area and the second drop-off area are powered by the first energy source 14 regardless of the power consumption of the individual circuits, which is generally indicated by reference number 120. When the current state of charge 98 is less than or equal to the first drop-off limit 78 and the current state of charge 98 is greater than the second drop-off limit 82, the circuits in the plurality of circuits 22 that are categorized into the second drop-off area are powered by the first energy source 14, whereas the circuits in the plurality of circuits 22 that are categorized into the first drop-off area are powered by the second energy source 16, which is generally indicated by reference number 122. When the current state of charge 98 is less than or equal to the second drop-off limit 82, the none of the circuits in the plurality of circuits 22 are powered by the first energy source 14, as the plurality of circuits 22 is powered by the second energy source 16, which is generally indicated by reference number 124.

Returning to FIG. 2, the user will have the ability to set a plurality of drop-off limits, listed as DOL1 to DOLN, where the drop-off limit DOLN-1 is calibrated at a value greater than the value of the drop-off limit DOLN, creating a plurality of drop-off areas, listed as DOA1 to DOAN. Each individual drop-off area from the plurality of drop-off areas is defined between two consecutive drop-off limits from the plurality of drop-off limits, meaning that the number of drop-off areas in the plurality of drop-off areas will be one fewer than the number of drop-off limits in the plurality of drop-off limits. The user will set a plurality of drop-off limit powers, listed as DOLP1 to DOLPN, to correspond with the respective drop-off limits from the plurality of drop-off limits. The circuits from the plurality of circuits 22 that consume power greater than or equal to the drop-off limit power DOLPN-1 but consume less power than DOLPN are classified into the drop-off area DOAN and are powered by the first energy source 14. The circuits from the plurality of circuits 22 that consume power less than the drop-off limit power DOLPN-1 are not classified into the drop-off area DOAN and are powered by the second energy source 16. The drop-off limit DOLN would be a minimum drop-off limit, meaning that when the current state of charge 98 is less than or equal to the drop-off limit DOLN, the first energy source 14 will no longer power any of the plurality of circuits 22 and the plurality of circuits 22 will be powered by the second energy source 16.

Referring to FIG. 4, when there are the plurality of drop-off limits, the plurality of drop-off areas, and the plurality of drop-off areas, when the current state of charge 98 is less the drop-off limit DOLN-1 and the current state of charge 98 is greater than the drop-off limit DOLN, the circuits from the plurality of circuits 22 that are classified into the drop-off area DOAN are powered by the first energy source 14. The circuits from the plurality of circuits 22 are not classified into the drop-off area DOAN are powered by the second energy source 16. When the current state of charge 98 is less than the drop-off limit DOLN, the first energy source 14 will no longer power any of the plurality of circuits 22 and the second energy source 16 will power the plurality of circuits 22.

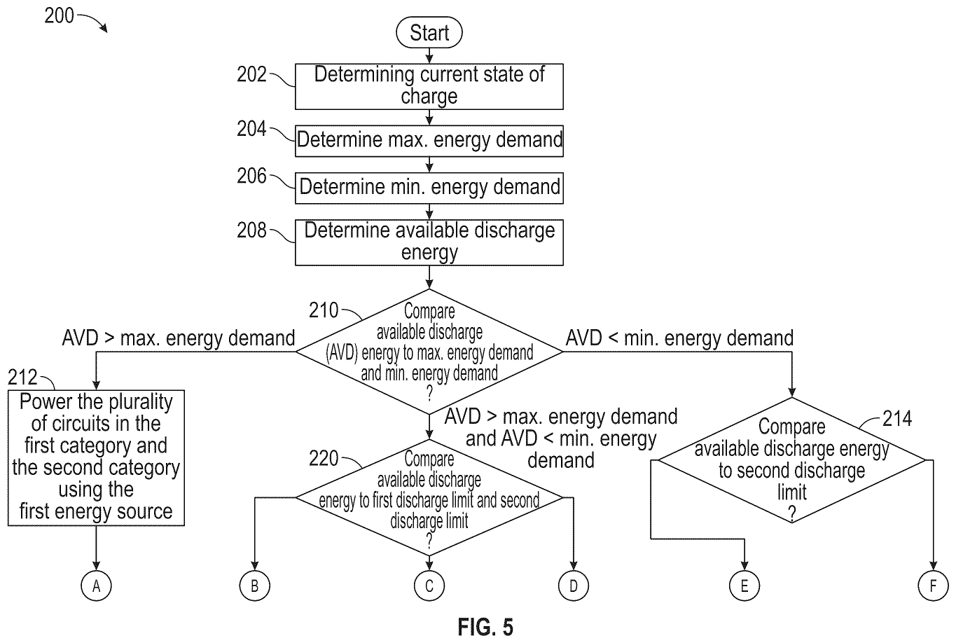

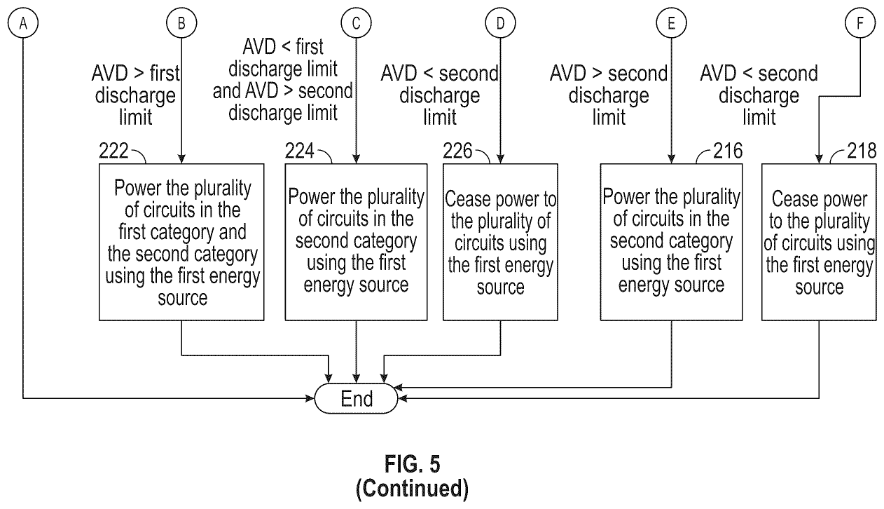

Referring to FIG. 5, a flow chart of a method for determining which of the plurality of circuits 22 are powered by the first energy source 14 using the digital break-out box 18 when the second energy source 16 is in an unpowered state 122 is generally indicated by reference number 200. In this example, it is presumed that the enable V2H input 62, the enable weather service input 64, and the enable power outage notification input 66 are calibrated to true, the first discharge limit 72 and the second discharge limit 74 are calibrated by the user, and each of the individual circuits in the plurality of circuits 22 are categorized into the first category 68 and the second category 70. Additionally, the second energy source 16 is determined to be in the unpowered state 122 when the digital break-out box 18 is not receiving power from the second energy source 16.

The method 200 begins at step 202 by determining the current state of charge 98 from the current state of charge input 58 received from the first energy source 14. In one example, the current state of charge 98 is determined by measuring the voltage of the first energy source 14. In another example, the current state of charge 98 is determined by measuring the specific gravity of the first energy source 14 using the electrolyte of first energy source 14. The method 200 then proceeds to step 204.

At step 204 the method 200 determines a maximum energy demand 124 of the plurality of circuits 22 using the digital break-out box 18. In an example, the maximum energy demand 124 is determined to be the larger value between the total power consumption of the plurality of circuits in the first category 68 multiplied by the storm time 48 and the total power consumption of the plurality of circuits in the first category 68 multiplied by the power outage time 52. The maximum energy demand 124 is then recorded in the memory 32. In another example, when both the enable power outage notification 52 and the enable weather service input 64 are calibrated to false, the maximum energy demand 124 is determined to be the total power consumption of the plurality of circuits in the first category 68 multiplied by a calibrated length of time that is based on a default backup duration. For example, the calibrated length of time is set to 72 hours. The maximum energy demand 124 is then recorded in the memory 32. The method 200 then proceeds to step 206.

At step 206 the method 200 determines a minimum energy demand 126 of the plurality of circuits 22 using the digital break-out box 18. In an example, the minimum energy demand 126 is determined to be the larger value between the total power consumption of the plurality of circuits belonging to the second category 70 multiplied by the storm time 48 and the total power consumption of the plurality of circuits belonging to the second category 70 multiplied by the power outage time 52. The minimum energy demand 126 is then recorded in the memory 32. In another example, when both the enable power outage notification 52 and the enable weather service input 64 are calibrated to false, the minimum energy demand 126 is determined to be the total power consumption of the plurality of circuits belonging to the second category 70 multiplied by a calibrated length of time that is based on the default backup duration. The minimum energy demand 126 is then recorded in the memory 32. The method 200 then proceeds to step 208.

At step 208 the method 200 determines the available discharge energy 90 of the first energy source 14. The available discharge energy 90 is determined as described in FIG. 3 above. The method 200 then proceeds to step 210.

At step 210 the method 200 compares the available discharge energy 90 to the maximum energy demand 124 and the minimum energy demand 126. When the available discharge energy 90 is greater than the maximum energy demand 124, the method 200 then proceeds to step 212.

At step 212, the first energy source 14 is used to power the plurality of circuits in the first category 68 and the second category 70.

Returning to step 210, the method 200 compares the available discharge energy 90 to the maximum energy demand 124 and the minimum energy demand 126. When the available discharge energy 90 is less than the minimum energy demand 126, the method 200 then proceeds to step 214.

At step 214, the method 200 compares the available discharge energy 90 to the second discharge limit 74. When the available discharge energy 90 is greater than the second discharge limit 74, the method 200 then proceeds to step 216. In another example, when there are the plurality of discharge limits, the method 200 compares the available discharge energy 90 to discharge limit DLN. When the available discharge energy 90 is greater than the discharge limit DLN, the method 200 then proceeds to step 216.

At step 216, the first energy source 14 is used to power the plurality of circuits in the second category 70. In another example, when there are the plurality of categories, the method 200 concludes at step 216 using the first energy source 14 to power the plurality of circuits in the CN category.

Returning to step 214, the method 200 compares the available discharge energy 90 to the second discharge limit 74. When the available discharge energy 90 is less than the second discharge limit 74, the method 200 then proceeds to step 218. In another example, when there are the plurality of discharge limits, the method 200 compares the available discharge energy 90 to discharge limit DLN. When the available discharge energy 90 is less than or equal to the discharge limit DLN, the method 200 then proceeds to step 218.

At step 218, the first energy source 14 ceases to power the plurality of circuits 22.

Returning to step 210, the method 200 compares the available discharge energy 90 to the maximum energy demand 124 and the minimum energy demand 126. When the available discharge energy 90 is less than the minimum energy demand 126 and the available discharge energy 90 is greater than the maximum energy demand 124, the method 200 then proceeds to step 220.

At step 220, the method 200 compares the available discharge energy 90 to the first discharge limit 72 and the second discharge limit 74. When the available discharge energy 90 is greater than the first discharge limit 72, the method 200 then proceeds to step 222.

At step 222, the first energy source 14 is used to power the plurality of circuits in the first category 68 and the second category 70.

Returning to step 220, the method 200 compares the available discharge energy 90 to the first discharge limit 72 and the second discharge limit 74. When the available discharge energy 90 is less than the first discharge limit 72 and the available discharge energy 90 is greater than the second discharge limit 74, the method then proceeds to step 224. In another example, when there are the plurality of discharge limits, when the available discharge energy 90 is less than the discharge limit DLN-1 and the available discharge energy 90 is greater than the discharge limit DLN, the method then proceeds to step 224.

At step 224, the first energy source 14 is used to power the plurality of circuits in the second category 70. In another example, when there are the plurality of categories, the first energy source 14 is used to power the plurality of circuits in the CN category.

Returning to step 220, the method 200 compares the available discharge energy 90 to the first discharge limit 72 and the second discharge limit 74. When the available discharge energy 90 is less than the second discharge limit 74, the method 200 then proceeds to step 226. In another example, when there is the plurality of discharge limits, when the available discharge energy 90 is less than the discharge limit DLN, the method 200 then proceeds to step 226.

At step 226, the first energy source 14 ceases to power the plurality of circuits 22.

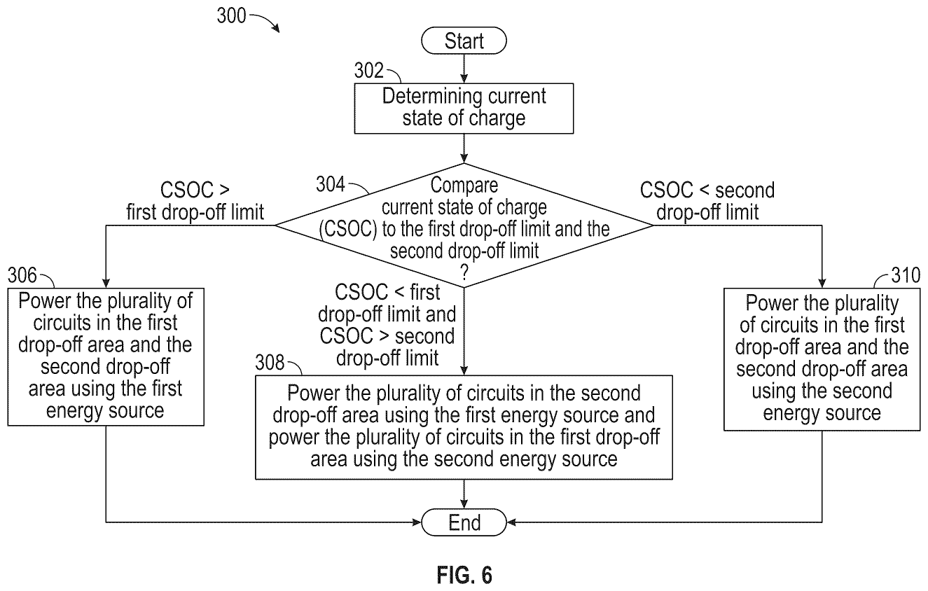

Referring to FIG. 6, a flow chart of a method for determining which of the plurality of circuits 22 are powered by the first energy source 14 and which of the plurality of circuits 22 are powered by the second energy source 16 using the digital break-out box 18 when the second energy source 16 is in an powered state 128 is generally indicated by reference number 300. In this example, it is presumed that the enable V2H input 62 is calibrated to true, the first drop-off limit 78, the second drop-off limit 82, the first drop-off limit power 80, and the second drop-off limit power 84 are calibrated by the user, and each of the individual circuits in the plurality of circuits 22 are categorized into the first drop-off area and the second drop-off area. The second energy source 16 is determined to be in the powered state 128 when the digital break-out box 18 is receiving power from the second energy source 16.

The method 300 begins at step 302 determining the current state of charge 98 from the current state of charge input 58 from the first energy source 14. In one example, the current state of charge 98 is determined by measuring the voltage of the first energy source 14. In another example, the current state of charge 98 is determined by measuring the specific gravity of the first energy source 14 using the electrolyte of the first energy source 14. The method 300 then proceeds to step 304.

At step 304, the method 300 compares the current state of charge 98 to the first drop-off limit 78 and the second drop-off limit 82. When the current state of charge 98 is greater than the first drop-off limit 78, the method 300 then proceeds to step 306.

At step 306 the first energy source 14 is used to power the plurality of circuits in the first drop-off area and the second drop-off area.

Returning to step 304, the method 300 compares the current state of charge 98 to the first drop-off limit 78 and the second drop-off limit 82. When the current state of charge 98 is less than the first drop-off limit 78 and the current state of charge 98 is greater than the second drop-off limit 82, the method 300 then proceeds to step 308. In another example, when there is the plurality of drop-off limits, when the current state of charge 98 is less than the drop-off limit DOLN-1 and the current state of charge 98 is greater than the drop-off limit DOLN, the method then proceeds to step 308.

At step 308, the first energy source 14 is used to power the plurality of circuits in the second drop-off area and the second energy source 16 is used to power the plurality of circuits in the first drop-off area. In another example, when there are the plurality of drop-off areas, the first energy source 14 is used to power the plurality of circuits in the DOAN drop-off area and the second energy source 16 is used to power the plurality of circuits not in the DOAN drop-off area.

Returning to step 304, the method 300 compares the current state of charge 98 to the first drop-off limit 78 and the second drop-off limit 82. When the current state of charge 98 is less than or equal to the second drop-off limit 82, the method 300 then proceeds to step 310. In another example, when there are the plurality of drop-off limits, the method 300 compares the current state of charge 98 to drop-off limit DOLN. When the current state of charge 98 is less than or equal to the drop-off limit DOLN, the method 300 then proceeds to step 310.

At step 310, the second energy source 16 is used to power the plurality of circuits in the first drop-off area and the second drop-off area. In another example, when there are the plurality of drop-off limits and the plurality of drop-off areas, the second energy source 16 is used to power the plurality of circuits in the plurality of drop-off areas.

The digital break-out box 18 of the present disclosure offers several advantages. These include: providing flexibility in configuring circuity based on specific needs, especially in anticipation of a power outage or a storm, removing the need for an electrician to change an existing circuity configuration, and maximizing cost efficiency with respect to energy consumption.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for customizing which of a plurality of circuits are connected to one of a first energy source and a second energy source using a digital break-out box, the method comprising:
determining a state of the second energy source, wherein the state includes one of: a powered state and an unpowered state;
when the state is in the unpowered state, further comprising:
determining the energy source to be the first energy source;
determining a current state of charge of the first energy source;
setting at least a first discharge limit and a second discharge limit of the first energy source;
classifying the circuits of the plurality of circuits into at least a first category and a second category;
determining a maximum energy demand based on the energy used by the plurality of circuits over a time period;
determining a minimum energy demand based on the energy used by the plurality of circuits in the first category over the time period;
determining an available discharge energy based on the summation of each limit subtracted from the current state of charge multiplied by an energy battery capacity; and
comparing the available discharge energy to the first discharge limit and the second discharge limit to determine which of the plurality of circuits will be powered by the first energy source when the available discharge energy is less than the minimum energy demand and the available discharge energy is greater than the maximum energy demand.

2. The method from claim 1, wherein setting the first discharge limit and the second discharge limit further comprises:
setting the first discharge limit to a first calibrated value based on discharge energy;
setting the second discharge limit to a second calibrated value based on discharge energy; and
wherein the first calibrated value is greater than the second calibrated value.

3. The method from claim 2, wherein classifying the circuits of the plurality of circuits into at least a first category and a second category further comprises:
classifying the circuits of the plurality of circuits into the first category based on a user's arbitrary preferences; and
classifying the circuits of the plurality of circuits into the second category based on the user's arbitrary preferences.

4. The method from claim 2, wherein determining the maximum energy demand further comprises:
taking the total value of the power used by the plurality of circuits in the first category and multiplying the total value by a calibrated value of time.

5. The method from claim 2, wherein determining the maximum energy demand further comprises:
taking the greater value between the power used by the plurality of circuits in the first category multiplied by a storm time and the power used by the plurality of circuits in the first category multiplied by a power outage time.

6. The method from claim 2, wherein determining the minimum energy demand further comprises:
taking the total amount of the power used by the plurality of circuits in the second category and multiplying the total value by a calibrated value of time.

7. The method from claim 2, wherein determining the minimum energy demand further comprises:
taking the greater value between the power used by the plurality of circuits in the second category multiplied by a storm time and the power used by the plurality of circuits in the second category multiplied by a power outage time.

8. The method from claim 2, wherein determining which of the plurality of circuits will be powered by the first energy source further comprises:
powering the plurality of circuits in the first category and the second category when the available discharge energy is greater than the first discharge limit.

9. The method from claim 2, wherein determining which of the plurality of circuits will be powered by the first energy source further comprises:
powering the plurality of circuits in the second category when the available discharge energy is less than the first discharge limit and the available discharge energy is greater than the second discharge limit.

10. The method from claim 2, wherein determining which of the plurality of circuits will be powered by the first energy source further comprises:
powering the plurality of circuits in the first category and the second category when the available discharge energy is greater than the maximum energy demand.

11. The method from claim 2, wherein determining which of the plurality of circuits will be powered by the first energy source further comprises:
powering the plurality of circuits in the second category when the available discharge energy is less than the minimum energy demand and the available discharge energy is greater than the second discharge limit.

12. The method from claim 1, wherein the first energy source is a vehicle.

13. A method for customizing which of a plurality of circuits are connected to one of a first energy source and a second energy source using a digital break-out box, the method comprising:
determining a state of the second energy source, wherein the state includes one of: a powered state and an unpowered state;
when the state is in the powered state, further comprising:
determining a current state of charge of the first energy source;
setting at least a first drop-off limit with a corresponding first drop-off limit power and a second drop-off limit with a corresponding second drop-off limit power of the first energy source;
classifying the circuits of the plurality of circuits into at least a first drop-off area and a second drop-off area; and
comparing the current state of charge to the first drop-off limit and the second drop-off limit to determine which energy source will power the plurality of circuits.

14. The method from claim 13, wherein setting the first drop-off limit and the second drop-off limit further comprises:
setting the first drop-off limit to a third calibrated value based on the current state of charge;
setting the first drop-off limit power to a fourth calibrated value in terms of power;
setting the second drop-off limit to a fifth calibrated value based on the current state of charge;
setting the second drop-off limit power to a sixth calibrated value in terms of power;
wherein the third calibrated value is greater than the fifth calibrated value; and
wherein the fourth calibrated value is less than the sixth calibrated value.

15. The method from claim 13, wherein classifying the circuits of the plurality of circuits into at least a first drop-off area and a second drop-off area further comprises:
determining the amount of power each individual circuit uses;
classifying the individual circuit into the first drop-off area when the amount of power the individual circuit uses is less than the first drop-off limit power; and
classifying the individual circuit into the second drop-off area when the amount of power the individual circuit uses is greater than or equal to the first drop-off limit power and is less than the second drop-off limit power.

16. The method from claim 13, wherein determining which energy source will power the plurality of circuits further comprises:
powering the plurality of circuits in the first drop-off area and the second drop-off area using the first energy source when the current state of charge is greater than the first drop-off limit.

17. The method from claim 13, wherein determining which energy source will power the plurality of circuits further comprises:
powering the plurality of circuits in the second drop-off area using the first energy source when the current state of charge is less than the first drop-off limit and the current state of charge is greater than the second drop-off limit; and
powering the plurality of circuits in the first drop-off area using the second energy source when the current state of charge is less than the first drop-off limit and the current state of charge is greater than the second drop-off limit.

18. The method from claim 13, wherein determining which energy source will power the plurality of circuits further comprises:
powering the plurality of circuits in the first drop-off area and the second drop-off area using the second energy source when the current state of charge is less than or equal to the second drop-off limit.

19. The method from claim 13, wherein the first energy source is a vehicle.

20. A method for customizing which of a plurality of circuits are connected to one of a first energy source and a second energy source using a digital break-out box, the method comprising:
determining a state of the second energy source, wherein the state includes one of: a powered state and an unpowered state;
when the state is in the unpowered state, further comprising:
determining the energy source to be the first energy source;
determining a current state of charge of the first energy source;
setting at least a first discharge limit and a second discharge limit of the first energy source;
classifying the circuits of the plurality of circuits into at least a first category and a second category;
determining a maximum energy demand based on the power used by the plurality of circuits in the first category over a time period;
determining a minimum energy demand based on the power used by the plurality of circuits in the second category over the time period;
determining an available discharge energy based on the summation of each limit subtracted from the current state of charge multiplied by an energy battery capacity; and
comparing the available discharge energy to the first discharge limit and the second discharge limit to determine which of the plurality of circuits will be powered by the first energy source when the available discharge energy is less than the minimum energy demand and the available discharge energy is greater than the maximum energy demand.
when the state is in the powered state, further comprising:
determining a current state of charge of the first energy source;
setting at least a first drop-off limit with a corresponding first drop-off limit power and a second drop-off limit with a corresponding second drop-off limit power of the first energy source;
classifying the circuits of the plurality of circuits into at least a first drop-off area and a second drop-off area; and
comparing the current state of charge to the first drop-off limit and the second drop-off limit to determine which energy source will power the plurality of circuits.
